(19) United States
(12) Patent Application Publication
(10) Pub. No.: US 2022/0258119 A1
(43) Pub. Date: Aug. 18, 2022

(54) ENCAPSULATION OF LIPOPHILIC ACTIVES WHICH ARE SENSITIVE TO ACID DEGRADATION

(71) Applicant: DSM IP Assets B.V., Heerlen (NL)

(72) Inventors: John David KRILL, Kaiseraugst (CH); Qiong TANG, Kaiseraugst (CH)

(21) Appl. No.: 17/627,564

(22) PCT Filed: Jul. 17, 2020
(86) PCT No.: PCT/EP2020/070237

§ 371 Date: Jan. 14, 2022

(30) Foreign Application Priority Data
Jul. 19, 2019 (EP) 19187183.9

(51) Int. Cl. B01J 13/10; A23P 10/35; B01J 13/14

(52) U.S. Cl. CPC B01J 13/10; B01J 13/14; A23P 10/35

(57) ABSTRACT

The invention relates to an easy and mild method of encapsulating lipophilic compounds. To induce coacervation, no acid needs to be added. Therefore, the coacervate capsules of the invention may encapsulate lipophilic actives which are sensitive to acid degradation. In a preferred embodiment of the invention, a vegetarian rapeseed protein isolate is used to encapsulate vegetarian algae oil. The thus obtained product is a vegetarian or even vegan source of polyunsaturated fatty acids.

### TECHNICAL FIELD

The present invention relates to the encapsulation of lipophilic actives which are used in food, feed, pharma and/or cosmetics.

### BACKGROUND OF THE INVENTION

There are multiple reasons for encapsulation of a lipophilic active.

Encapsulation may increase solubility of the active, may control the release of the active or may increase the stability of the active.

Various encapsulation methods are known. Unfortunately, they all have certain disadvantages.

A major issue is the complexity of known methods. Complexity can be due to the large number of starting materials that is needed. For complex coacervation, for example, at least two different polymers must be ordered separately. Thus, two suppliers need to be sourced, the shipment of two products must be organized and a sophisticated warehouse management system is needed.

Thus, there is a need for a method with lower complexity.

Lowering the complexity of encapsulation process is challenging because the material used for encapsulation must meet numerous criteria. At least, the material must be non-toxic. For application in food and feed, it must also be edible. For application in food and pharma, the material should be vegetarian or vegan. The material should originate from a non-genetically modified organism (non-GMO) which can be grown in a sustainable manner (i.e. using less resources).

Thus, there is a need for a method for encapsulation with edible, sustainable, non-GMO, vegetarian or vegan material, wherein the complexity of the method is decreased.

Some lipophilic actives which need to be encapsulated are sensitive to acid degradation. An example of such active is vitamin A. Therefore, the method for encapsulation should not involve a process step, wherein the pH must be lowered to less then 5 or even worse, to less than 4 or 3.

Thus, there is a need for a method for encapsulation with edible, sustainable, non-GMO, vegetarian or vegan material, wherein the method is suitable for encapsulating lipophilic actives which are sensitive to acid degradation and wherein the complexity of the method is decreased.

GB 935,812 discloses a coacervation process in a manner to enable pH-sensitive materials to be encapsulated. This prior art document relates to systems based on gelatine. Gelatine is neither vegetarian nor vegan.

### SUMMARY OF THE INVENTION

The problems underlying the present invention are solved by a method of encapsulating at least one lipophilic compound, said method comprising the steps:
a) selection of protein A, wherein said protein's isoelectric point pI(A) is from 6 to 8;
b) selection of protein B, wherein said protein's isoelectric point pI(B) is at least 9;
c) provision of a composition comprising (i) water, (ii) selected protein A and (iii) selected protein B;
d) addition of at least one lipophilic compound to the composition obtained in step c);
e) emulsification of the composition obtained in step d);
f) inducement of coacervation; and
g) optionally inducement of crosslinking.

In a preferred embodiment of the invention, one single protein isolate comprising both, protein A and B, is used for providing the composition of step c). Using one single starting material instead of two, three or even more different polymers significantly reduces the complexity of the process.

Thus, the present invention also relates to the use of a specified protein isolate for manufacturing coacervates.

The preferred protein isolate is vegan and vegetarian. Thus, gelatine is preferably not used in the method of the invention. Preferably, the protein isolate is an extract from a non-GMO, edible plant.

In a preferred embodiment of the invention, sustainability is achieved by using a protein isolate which is the by-product of an industrial process. Even more preferably, the protein isolate is an extract from the cold press cake obtained when cold crushing rapeseed such as cold crushing non-GMO rapeseed.

Thus, the present invention also relates to the use of a native rapeseed protein isolate for manufacturing coacervates.

Preferably, coacervation in step f) is not induced by lowering the pH of the composition obtained in step e). Instead, coacervation is induced either by increasing the pH of the emulsion obtained in step e) or by dilution of the emulsion obtained in step e) with water. Thus, lipophilic actives can be encapsulated even if they are sensitive to acid.

The present invention also relates to coacervate capsules which are obtainable by the method of the invention. Such capsules are stable, edible, vegan, vegetarian, non-GMO, free of organic solvents and/or effectively protect the lipophilic active from e.g. oxidation. In addition, such capsules are easy to manufacture and may also encapsulate an active which is sensitive to acid.

### DETAILED DESCRIPTION OF THE INVENTION

The present invention relates to the use of at least two proteins (protein A and protein B) for encapsulating lipophilic compounds by coacervation. Proteins are large biomolecules, or macromolecules, comprising or consisting of one or more long chains of amino acid residues.

In one embodiment of the invention, one single protein isolate which comprises both proteins is used to encapsulate at least one lipophilic compound. Preferably, said protein isolate is the native rapeseed protein isolate disclosed in WO 2018/007493. The rapeseed protein isolate disclosed in WO 2018/007493 is different from ordinary rapeseed protein; it consists essentially of cruciferin and napin and has a significantly higher solubility in water than ordinary rapeseed protein. Surprisingly, coacervates can be easily formed with the rapeseed protein isolate disclosed in WO 2018/007493. Thus, one embodiment of the present invention relates to the use of the rapeseed protein isolate disclosed in WO 2018/007493 for manufacturing coacervates. Preferably, said coacervates encapsulate at least one lipophilic compound.

When applying the method of the invention, a slurry is obtained which comprises the coacervates of the invention. To obtain a powder, said slurry may then be spray dried. The obtained powder comprises a lipophilic compound that is at least partially encapsulated.

Thus, the present invention also relates to the use of the native rapeseed protein isolate disclosed in WO 2018/007493 for manufacturing a slurry that comprises coacervates. Preferably, said coacervates encapsulate at least one lipophilic compound. The present invention also relates to the use of the native rapeseed protein isolate disclosed in WO 2018/007493 for manufacturing a powder that comprises coacervates, wherein said coacervates encapsulate at least one lipophilic compound which is preferably sensitive to acid degradation.

### Method of the Invention

The method of the present invention is a method of encapsulating at least one lipophilic compound. It comprises several steps which are explained in more detail in the following paragraphs.

Step a) and Step b)

Step a) comprises the selection of protein A. Any protein can be selected as protein A provided the protein's isoelectric point pI(A) is from 6 to 8. Thereby, pI(A) is preferably from 6.5 to 8, more preferably from 6.5 to 7.5 and most preferably from 7 to 7.5. The isoelectric point “pI” is the pH at which a particular protein carries no net electrical charge or is electrically neutral in the statistical mean. In a preferred embodiment of the present invention, pI is elecrophoretic mobility of proteins measured as follows: Elecrophoretic mobility of proteins is measured using a Malvern Zetasizer Nano ZS (Malvern Instrument Ltd., Malvern, UK). The analysis is conducted with using a disposable capillary cuvette equipped with gold electrodes in which 800 μL of protein solution was added. The proteins are solubilized in MilliQ water and buffers with a pH range from 3 to 8 are added in order. Electrophoretic mobility is measured calculating zeta potential, a technique in which a voltage is applied across a pair of electrodes at either end of a cell containing the protein solution. Zeta potential is measured at every pH step defined with the autotritator. MilliQ water was produced by a Millipore Milli-Q system, producing nanopure water with a water conductivity of 18 mΩ. The expression “pI(A) refers to the isoelectric point of protein A. In a preferred embodiment of the invention, protein A is a globulin, is more preferably cruciferin, is even more preferably cruciferin originating from a vegetable source and is most preferably rapeseed cruciferin.

Step b) comprises the selection of protein B. Any protein can be selected as protein B provided the protein's isoelectric point pI(B) is at least 9. Thereby, pI(B) is preferably from 9 to 14, more preferably from 9.5 to 13 and most preferably from 10 to 12. The expression “pI(B) refers to the isoelectric point of protein B. In a preferred embodiment of the invention, protein B is an albumin, is more preferably napin, is even more preferably napin originating from a vegetable source, and is most preferably rapeseed napin.

Globulins (such as cruciferin) are poorly soluble or even insoluble in pure water and have higher molecular weights than albumins (such as napin).

In a preferred embodiment of the invention, step a) and step b) are done by choosing a protein isolate that comprises both, protein A and protein B. In this embodiment, protein A and protein B are preferably vegetable proteins, and are more preferably non-genetically modified vegetable proteins. Thereby, protein A is preferably a globulin and protein B is preferably an albumin.

Also preferably, step a) and step b) are done by choosing a protein isolate that comprises cruciferin and napin. Even more preferably step a) and step b) are done by choosing a protein isolate that comprises rapeseed cruciferin and rapeseed napin, wherein said protein isolate is preferably a native rapeseed protein isolate comprising 40 to 65% on dry matter of cruciferins and 35 to 60% on dry matter of napins and/or having a solubility of at least 88% when measured over a pH range from 3 to 10 at a temperature of 23±2° C. Thereby, solubility is measured as explained in WO 2018/007493. The preferred native rapeseed protein isolate comprises from 5% to 65% on dry matter of 12S rapeseed protein where the presence of 12S is verified by Blue Native PAGE. Thereby, MW determination by Blue Native PAGE is explained in more detail in WO 2018/007493.

The most preferred protein isolate of the invention is the native rapeseed protein isolate of claim 1 of WO 2018/007493. Such protein isolate is commercially available under the tradename CanolaPRO™ at DSM® Nutritional Products, Switzerland.

Step c)

Step c) comprises the provision of a composition comprising (i) water, (ii) selected protein A and (iii) selected protein B.

In a preferred embodiment, a composition comprising (i) water, (ii) cruciferin and (iii) napin is provided in step c). This can be done by mixing the rapeseed protein isolate disclosed in WO 2018/007493 with water. Commercially available CanolaPRO™ has a surprisingly high solubility in water which facilitates step c).

In a preferred embodiment, a composition comprising water and a rapeseed protein isolate is provided in step c), wherein said rapeseed protein isolate has a solubility of at least 88% when measured over a pH range from 3 to 10 at a temperature of 23±2° C. Thereby, the rapeseed protein isolate is preferably a native rapeseed protein isolate that comprises 40 to 65% on dry matter of cruciferins and 35 to 60% on dry matter of napins and/or comprises from 5% to 65% on dry matter of 12S rapeseed protein where the presence of 12S is verified by Blue Native PAGE.

Optionally, the composition provided in step c) comprises at least one further polymer, wherein said further polymer is preferably not gelatine. Thus, in an embodiment of the invention, step c) comprises the provision of a composition comprising (i) water, (ii) cruciferin, (iii) napin and at least one further polymer, wherein said at least one further polymer is preferably vegan and/or vegetarian. In a preferred embodiment, the at least one further polymer is a polysaccharide. Even more preferably, the at least one further polymer is a swellable polysaccharide. Swellable polysaccharides are hydrocolloids and include compounds such as Gum Arabic, pectin and carrageenan. Thus, in a preferred embodiment of the invention, step c) comprises the provision of a composition comprising (i) water, (ii) cruciferin, (iii) napin and at least one swellable polysaccharide, wherein said at least one swellable polysaccharide is preferably selected from the group consisting of Gum Arabic, pectin and carrageenan, and wherein the at least one swellable polysaccharide is most preferably Gum Arabic.

Step d)

Step d) comprises the addition of at least one lipophilic compound to the composition obtained in step c). Preferably, the at least one lipophilic compound is an oil, wherein said oil comprises preferably polyunsaturated fatty acids, and wherein said oil is preferably fish oil comprising polyunsaturated fatty acids or algae oil comprising polyunsaturated fatty acids, and wherein said oil comprises preferably docosahexaenoic acid (DHA) and/or eicosapentaenoic acid (EPA). In the context of the present invention, fish oil comprising polyunsaturated fatty acids and algae oil comprising polyunsaturated fatty acids are referred to as “PUFA oil”. Thus, step d) comprises preferably the addition of at least one PUFA oil to the composition obtained in step c). As a source of polyunsaturated fatty acids, vegans and vegetarians prefer algae oil. Fish oil is neither vegan nor vegetarian. Thus, even more preferably, step d) comprises the addition of algae oil to the composition obtained in step c), wherein said algae oil comprises polyunsaturated fatty acids, and wherein said algae oil comprises preferably docosahexaenoic acid (DHA) and/or eicosapentaenoic acid (EPA). Such algae oil is available under the tradename life'sDHA™ S40 at DSM® Nutritional Products, Switzerland. Life′sDHA™ S40 is a nutritional oil that contains at least 40 weight-% DHA, based on the total weight of the oil.

Encapsulating lipophilic compounds that are sensitive to acid is particularly challenging because many coacervation methods induce coacervation by the addition of acid. The method of the present invention does not require the addition of acid and is therefore suitable for encapsulating lipophilic compounds that are sensitive to acid.

In one embodiment of the invention, step d) comprises the addition of a lipophilic compound that is sensitive to acid. In a preferred embodiment, the at least one lipophilic compound is selected from the group consisting of vitamins, carotenoids, lipids, edible polymers and active pharmaceutical ingredients. Thus, in one embodiment, step d) comprises the addition of a lipophilic compound that is selected from the group consisting of vitamins, carotenoids, lipids, edible polymers and active pharmaceutical ingredients to the composition obtained in step c).

Step e)

Step e) comprises the emulsification of the composition obtained in step d). Thereby, emulsification can be done in any suitable manner, e.g. be vigorous stirring. In the context of the present invention, a Malvern Mastersizer 3000 is preferably used for measuring the particle size. Preferably, step e) is done such that oil droplets having an average particle size D (v,0.5) from 0.1 μm to 10 μm, preferably from 0.1 μm to 5, and most preferably from 1.5 μm to 2.5 μm, measured by Laser Diffraction; Malvern Mastersizer 3000, MIE volume distribution, are obtained.

In one embodiment of the method of the invention, the emulsion of claim 1 of WO 2018/007508 is provided in step e).

In a preferred embodiment, the emulsion obtained in step e) comprises or consists of:
i) at least 30 weight-%, preferably at least 40 weight-% and most preferably at least 50 weight-% water, based on the total weight of the composition;
ii) from 1 to 10 weight-%, preferably from 2 to 9 weight-% and most preferably from 3 to 8 weight-% protein A, based on the total weight of the composition;
iii) from 1 to 10 weight-%, preferably from 2 to 9 weight-% and most preferably from 3 to 8 weight-% protein B, based on the total weight of the composition;
iv) from 1 to 60 weight-%, preferably from 1 to 50 weight-% and most preferably from 1 to 40 weight-% of the at least one lipophilic compound, based on the total weight of the composition; and
v) optionally at least one further excipient,
   wherein the amounts of compounds i) to v) are selected such that they add up to 100 weight-%.

In an even more preferred embodiment, the emulsion obtained in step e) comprises or consists of:
i) at least 30 weight-%, preferably at least 40 weight-% and most preferably at least 50 weight-% water, based on the total weight of the composition;
ii) from 1 to 10 weight-%, preferably from 2 to 9 weight-% and most preferably from 3 to 8 weight-% cruciferin, based on the total weight of the composition;
iii) from 1 to 10 weight-%, preferably from 2 to 9 weight-% and most preferably from 3 to 8 weight-% napin, based on the total weight of the composition;
iv) from 1 to 60 weight-%, preferably from 1 to 50 weight-% and most preferably from 1 to 40 weight-% of an oil comprising docosahexaenoic acid (DHA) and/or eicosapentaenoic acid (EPA), based on the total weight of the composition; and
v) optionally Gum Arabic,
   wherein the amounts of compounds i) to v) are selected such that they add up to 100 weight-%.

In the most preferred embodiment, the emulsion obtained in step e) comprises or consists of:
i) at least 30 weight-%, preferably at least 40 weight-% and most preferably at least 50 weight-% water, based on the total weight of the composition;
ii) from 2 to 20 weight-%, preferably from 4 to 18 weight-% and most preferably from 6 to 16 weight-% of at least one protein isolate, based on the total weight of the composition;
iii) from 1 to 60 weight-%, preferably from 1 to 50 weight-% and most preferably from 1 to 40 weight-% of an oil comprising docosahexaenoic acid (DHA) and/or eicosapentaenoic acid (EPA), based on the total weight of the composition; and
iv) optionally Gum Arabic,
   wherein said protein isolate is preferably rapeseed protein isolate and wherein said rapeseed protein isolate is more preferably a native rapeseed protein isolate comprising 40 to 65% on dry matter of cruciferins and 35 to 60% on dry matter of napins and/or having a solubility of at least 88% when measured over a pH range from 3 to 10 at a temperature of 23±2° C., and
   wherein the amounts of compounds i) to iv) are selected such that they add up to 100 weight-%.

Step f)

In step f), the emulsion obtained in step e) is treated to induce coacervation. Known methods for inducing coacervation are dilution with water, heating, change of pH, radiation or a combination of thereof.

In a one embodiment, coacervation in step f) is induced by increasing the pH of the composition obtained in step e), preferably to pI(A)<pH<pI(B). The pH of the composition obtained in step e) may be increased by adding a base such as NaOH. Without wishing to be bound by theory, it has been hypothesized that at a pH above pI(A), randomly charged patches appear on the surface of protein (A) which facilitate coacervation. Surprisingly, this mechanism works particularly well if protein A is cruciferin and if protein B is napin. In case protein A is cruciferin and protein B is napin, coacervation in step f) is induced by increasing the pH of the composition obtained in step e) to a pH preferably from 7.8 to 8.2 and more preferably to a pH of 8.

Depending on the composition obtained in step e), a pH adjustment might not be necessary. Surprisingly, if the composition provided in step c) comprises (i) water, (ii) cruciferin, (iii) napin and Gum Arabic, coacervation in step f) can be induced by dilution only. Gum Arabic's pI is very low (around pH 1.8) and thus, no pH adjustment is necessary if the composition provided in step c) comprises in addition to cruciferin and napin also Gum Arabic. This is a particularly easy and a particularly mild method, suitable for encapsulation of lipophilic actives which are sensitive to acid degradation.

In step f), coacervate capsules or agglomerations of coacervate capsules are obtained. Thereby, the average particle size D (v,0.5) can be controlled by adding water to the emulsion obtained in step e) before inducing coacervation. The more water is added, the larger the average particle size will be.

Optional Step g)

After having induced coacervation, the least one lipophilic compound is partially or fully encapsulated by protein A, protein B and the optional at least one further polymer. To increase stability of the obtained coacervates, the method of the present invention comprises optional step g).

In optional step g), the composition obtained in step f) is treated to induce crosslinking. Thereby, crosslinking can be done in any suitable manner, e.g. by irradiation or enzymatically. Crosslinking in step g) is preferably induced by adding a crosslinking agent to the composition obtained in step f), wherein said crosslinking agent is preferably an enzyme, and wherein said enzyme is preferably transglutaminase. In one embodiment, crosslinking in step g) is induced by adding from 0.1 weight-% to 1.5 weight-%, preferably from 0.2 weight-% to 1 weight-%, even more preferably from 0.3 weight-% to 0.7 weight-%, and most preferably 0.5 weight-% transglutaminase to the composition obtained in step f), based on the total weight of the composition obtained in step f).

Optional Step h)

The composition obtained in step f) or step g) is a slurry that comprises water. Typically, the slurry comprises at least 30 weight-%, preferably at least 40 weight-% and most preferably at least 50 weight-% water, based on the total weight of the composition.

In one embodiment, the slurry is ready to be used. Preferably however, the composition obtained in step f) or step g) is spray dried to obtain a powder. Thus, optional step h) comprises the step of spray drying the composition obtained in step f) or the step of spray drying the composition obtained step g).

### Preferred Embodiment (without Gum Arabic)

In a preferred embodiment, no Gum Arabic is used in the method of the invention. In this preferred embodiment, the method of encapsulating at least one lipophilic compound comprises the steps:
a) selection of protein A, wherein said protein's isoelectric point pI(A) is from 6 to 8;
b) selection of protein B, wherein said protein's isoelectric point pI(B) is at least 9;
c) provision of a composition comprising (i) water, (ii) selected protein A and (iii) selected protein B;
d) addition of at least one lipophilic compound to the composition obtained in step c);
e) emulsification of the composition obtained in step d); and
f) inducement of coacervation by increasing the pH of the composition obtained in step e) to pI(A)<pH<pI(B);
g) inducement of crosslinking, preferably by adding a crosslinking agent to the composition obtained in step f) or by heating to the composition obtained in step f).

In an even more preferred embodiment, the method of encapsulating at least one lipophilic compound comprises the steps:
a) selection of cruciferin as protein A;
b) selection of napin as protein B;
c) provision of a composition comprising (i) water, (ii) cruciferin and (iii) napin,
d) addition of at least one PUFA oil to the composition obtained in step c), wherein said PUFA oil is preferably an algae oil which comprises polyunsaturated fatty acids;
e) emulsification of the composition obtained in step d); and
f) inducement of coacervation by increasing the pH of the composition obtained in step to a pH from 7.8 to 8.2 and preferably to a pH of 8;
g) inducement of crosslinking, preferably by heating to the composition obtained in step f) to a temperature from 60° C. to 80° C. or to a temperature from 60° C. to 90° C., and preferably to a temperature of 69° C. to 71° C.

In the most preferred embodiment, the method of encapsulating at least one lipophilic compound comprises the steps:
i. provision of a composition comprising water and at least one protein isolate;
ii. addition of at least one PUFA oil to the composition obtained in step i), wherein said PUFA oil is preferably an algae oil which comprises polyunsaturated fatty acids;
iii. emulsification of the composition obtained in step ii); and
iv. inducement of coacervation by increasing the pH of the composition obtained in step to a pH from 7.8 to 8.2 and preferably to a pH of 8;
v. inducement of crosslinking, preferably by heating to the composition obtained in step iv) to a temperature from 60° C. to 80° C. or to a temperature from 60° C. to 90° C., and preferably to a temperature of 69° C. to 71° C.,
   wherein said protein isolate is preferably a rapeseed protein isolate and wherein said rapeseed protein isolate is more preferably a native rapeseed protein isolate comprising 40 to 65% on dry matter of cruciferins and 35 to 60% on dry matter of napins and/or having a solubility of at least 88% when measured over a pH range from 3 to 10 at a temperature of 23±2° C.

### Preferred Embodiment (with Gum Arabic)

In an also preferred embodiment of the invention, Gum Arabic is used in addition to protein A and protein B. In this preferred embodiment, the method of encapsulating at least one lipophilic compound comprises the steps:
a) selection of protein A, wherein said protein's isoelectric point pI(A) is from 6 to 8;
b) selection of protein B, wherein said protein's isoelectric point pI(B) is at least 9;
c) provision of a composition comprising (i) water, (ii) selected protein A and (iii) selected protein B and further comprising Gum Arabic;
d) addition of at least one lipophilic compound to the composition obtained in step c);
e) emulsification of the composition obtained in step d); and
f) inducement of coacervation by dilution of the composition obtained in step, and preferably by adding water to the composition e);
g) inducement of crosslinking, preferably by adding a crosslinking agent to the composition obtained in step f) or by heating to the composition obtained in step f)

In an even more preferred embodiment, the method of encapsulating at least one lipophilic compound comprises the steps:
a) selection of cruciferin as protein A;
b) selection of napin as protein B;
c) provision of a composition comprising (i) water, (ii) cruciferin and (iii) napin and further comprising Gum Arabic;
d) addition of at least one PUFA oil to the composition obtained in step c), wherein said PUFA oil is preferably an algae oil which comprises polyunsaturated fatty acids;
e) emulsification of the composition obtained in step d); and
f) inducement of coacervation by dilution of the composition obtained in step, and preferably by adding water to the composition e);
g) inducement of crosslinking, preferably by adding a crosslinking agent and more preferably by adding an enzyme such as transglutaminase.

In the most preferred embodiment, the method of encapsulating at least one lipophilic compound comprises the steps:
i. provision of a composition comprising water, at least one protein isolate and further comprising Gum Arabic;
ii. addition of at least one PUFA oil to the composition obtained in step i), wherein said PUFA oil is preferably an algae oil which comprises polyunsaturated fatty acids;
iii. emulsification of the composition obtained in step ii); and
iv. inducement of coacervation by dilution of the composition obtained in step, and preferably by adding water to the composition iii);
v. inducement of crosslinking, preferably by adding a crosslinking agent and more preferably by adding an enzyme such as transglutaminase,
   wherein said protein isolate is preferably a rapeseed protein isolate and wherein said rapeseed protein isolate is more preferably a native rapeseed protein isolate comprising 40 to 65% on dry matter of cruciferins and 35 to 60% on dry matter of napins and/or having a solubility of at least 88% when measured over a pH range from 3 to 10 at a temperature of 23±2° C.

Coacervate Capsules of the Invention

Coacervate capsules of the present invention are obtainable by the herein disclosed method. In the herein described method, protein A and protein B are used. Therefore, the coacervate capsules of the invention comprise herein described protein A and herein described protein B.

In a preferred embodiment, the coacervate capsules of the invention comprise protein A and protein B, wherein protein A is a globulin and wherein protein B is an albumin, and wherein protein A is more preferably cruciferin and wherein protein B is more preferably napin, and wherein protein A is more preferably rapeseed cruciferin and wherein protein B is more preferably rapeseed napin. In an alternative embodiment, the coacervate capsules of the invention comprise protein A, protein B and at least one further polymer, wherein protein A is a globulin and wherein protein B is an albumin, and wherein protein A is more preferably cruciferin and wherein protein B is more preferably napin, and wherein protein A is more preferably rapeseed cruciferin and wherein protein B is more preferably rapeseed napin. In this alternative embodiment, the at least one further polymer is preferably a swellable polysaccharide, and is more preferably a hydrocolloid such as Gum Arabic, pectin, alginate, carboxymethylcellulose (CMC), gellan and carrageenan and is most preferably Gum Arabic.

In one embodiment, the coacervate capsules of the invention comprise protein A and protein B, wherein the weight ratio between protein A and protein B is between 3:1 and 1:3, preferably between 2:1 and 1:2 and most preferably between 1.5:1 and 1:1.5. Preferably, the coacervate capsules of the invention comprise rapeseed cruciferin and rapeseed napin, wherein the weight ratio between rapeseed cruciferin and rapeseed napin is between 3:1 and 1:3, preferably between 2:1 and 1:2 and most preferably between 1.5:1 and 1:1.5. In an alternative embodiment, the coacervate capsules of the invention comprise rapeseed cruciferin, rapeseed napin and at least one further polymer, wherein the weight ratio between rapeseed cruciferin and rapeseed napin is between 3:1 and 1:3, preferably between 2:1 and 1:2 and most preferably between 1.5:1 and 1:1.5. In this alternative embodiment, the at least one further polymer is preferably a swellable polysaccharide, is more preferably a hydrocolloid such as Gum Arabic, pectin and carrageenan and is most preferably Gum Arabic.

Encapsulation of the at least one lipophilic compound is more effective if the weight ratio between the at least one lipophilic compound and protein A is within certain ranges. In a preferred embodiment, the weight ratio between the at least one lipophilic compound and protein A is between 20:1 and 1:1, preferably between 15:1 and 2:1 and most preferably between 10:1 and 3:1.

Encapsulation of the at least one lipophilic compound is also more effective if the weight ratio between the at least one lipophilic compound and protein B is within certain ranges. In a preferred embodiment, the weight ratio between the at least one lipophilic compound and protein B is between 20:1 and 1:1, preferably between 15:1 and 2:1 and most preferably between 10:1 and 3:1.

Preferably, the coacervate capsules of the present invention comprise at least one protein isolate, wherein said at least one protein isolate is preferably a rapeseed protein isolate which comprises preferably cruciferin and napin. More preferably, a protein isolate that comprises rapeseed cruciferin and rapeseed napin, the coacervate capsules of the present invention comprise native rapeseed protein isolate comprising 40 to 65% on dry matter of cruciferins and 35 to 60% on dry matter of napins and/or having a solubility of at least 88% when measured over a pH range from 3 to 10 at a temperature of 23±2° C. and/or wherein said native rapeseed protein isolate comprises from 5% to 65% on dry matter of 12S rapeseed protein where the presence of 12S is verified by Blue Native PAGE. Such protein isolate is disclosed in WO 2018/007493 and is commercially available under the tradename CanolaPRO™ (DSM® Nutritional Products, Switzerland).

Preferably, the coacervate capsules of the present invention comprise algae oil, wherein said algae oil comprises polyunsaturated fatty acids, and wherein said algae oil comprises preferably docosahexaenoic acid (DHA) and/or eicosapentaenoic acid (EPA). Such algae oil is acceptable for vegans and/or vegetarians.

In the most preferred embodiment, the coacervate capsules of the present invention are free of gelatine and comprise the herein described protein isolate, the herein described algae oil, and optionally Gum Arabic. Such capsules are as source of polyunsaturated fatty acids that is acceptable for vegans and/or vegetarians.

### Use According to the Invention

The present invention also relates to the use of a protein isolate for manufacturing coacervates, wherein said protein isolate comprises protein A and protein B, and wherein the isoelectric point pI(A) of said protein A is from 6 to 8, and wherein the isoelectric point pI(B) of said protein B is at least 9. Thereby, protein A and protein B are preferably vegetable proteins.

A preferred embodiment of the present invention relates to the use of a protein isolate for manufacturing coacervates, wherein said protein isolate comprises protein A and protein B, wherein protein A is a globulin and wherein protein B is an albumin, and wherein protein A is more preferably cruciferin and wherein protein B is more preferably napin and wherein protein A is most preferably rapeseed cruciferin and wherein protein B is most preferably rapeseed napin.

An even more preferred embodiment of the present invention relates to the use of a protein isolate for manufacturing coacervates, wherein said protein isolate is native rapeseed protein isolate comprising 40 to 65% on dry matter of cruciferins and 35 to 60% on dry matter of napins and/or having a solubility of at least 88% when measured over a pH range from 3 to 10 at a temperature of 23±2° C. and wherein the native rapeseed protein isolate comprises preferably from 5% to 65% on dry matter of 12S rapeseed protein where the presence of 12S is verified by Blue Native PAGE.

### FIGURES

FIG. 1 shows a picture of the slurry obtained in Example 2. The picture has been taken under light microscope using 100× magnification. In FIG. 1, agglomerations of coacervates can be seen. The slurry is ready to be spray dried.

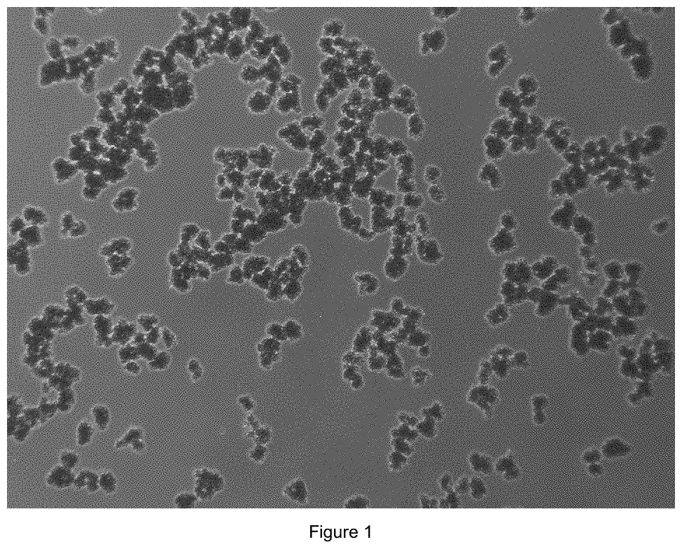

FIG. 2 also shows a picture of the slurry obtained in Example 2. The picture has been taken under light microscope using 400× magnification.

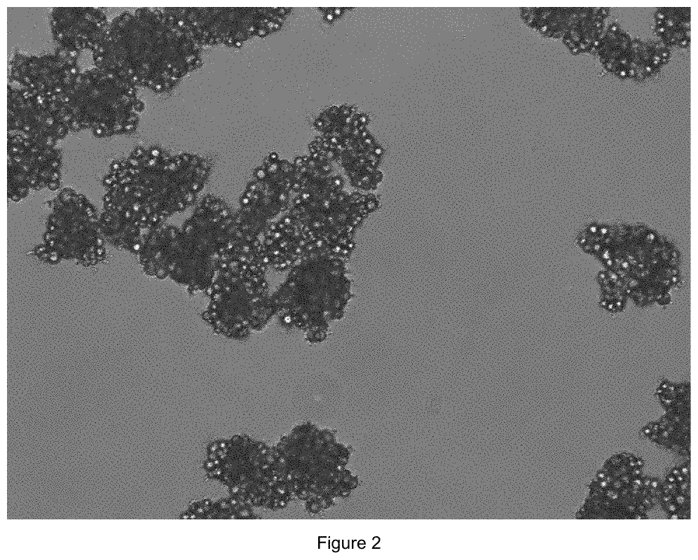

### EXAMPLES

### Example 1

In example 1, a powder comprising PUFA oil was manufactured as follows:

20 g of a native rapeseed protein isolate comprising cruciferin and napin (CanolaPRO™, available at DSM® Nutritional Products, Switzerland) was dissolved in 150 g water. 80 g PUFA oil (life'sDHA™ S40, available at DSM® Nutritional Products, Switzerland) was then added. The thus obtained mixture was then homogenized to obtain oil droplets having an average particle size D (v,0.5) of around 2 μm. Water was then added (500 g to 1000 g water, depending on the desired average particle size of coacervate capsules). Coacervation was then induced by adjusting the pH to 8 by adding 10% NaOH in drop wise. To induce crosslinking, temperature was increased to 70° C. and was maintained at 70° C. for 30 minutes. The thus obtained slurry was cooled down to room temperature before spray drying.

The obtained spray dried powder was free-flowing and was free of any unpleasant taste or smell.

### Example 2

In example 2, the process of example 1 was repeated. In example 2, however a further polymer (Gum Arabic) was added in addition to cruciferin and napin. When adding Gum Arabic, coacervation can be induced by dilution only, i.e. without pH adjustment.

In example 2, a powder comprising PUFA oil was manufactured as follows:

27 g of a native rapeseed protein isolate comprising cruciferin and napin (CanolaPRO™, available at DSM® Nutritional Products, Switzerland) was mixed with 3 g Gum Arabic (available at TIC Gums). The mixture was then dissolved in 150 g water. 70 g PUFA oil (life'sDHA™ S40, available at DSM® Nutritional Products, Switzerland) was then added. The thus obtained mixture was then homogenized to obtain oil droplets having an average particle size D (v,0.5) of around 2 μm. Coacervation was then induced by adding water. Surprisingly, due to the presence of Gum Arabic, a pH adjustment was not necessary. Thus, in contrast to Example 1, no NaOH was added. The mixture was then stirred until most of the foam died down (approx. 1 hour). To induce crosslinking, 0.5 weight-% transglutaminase, based on the total weight of the slurry, was added and the obtained mixture was kept at about 36° C. overnight. The thus obtained slurry was then spray dried.

The obtained spray dried powder was free-flowing and free of any unpleasant taste or smell.

1. A method of encapsulating at least one lipophilic compound, said method comprising:
a) selection of protein A, wherein said protein's isoelectric point pI(A) is from 6 to 8;
b) selection of protein B, wherein said protein's isoelectric point pI(B) is at least 9;
c) provision of a composition comprising (i) water, (ii) selected protein A and (iii) selected protein B and optionally at least one further polymer being optionally a swellable polysaccharide;
d) addition of at least one lipophilic compound to the composition obtained in c);
e) emulsification of the composition obtained in d); and
f) inducement of coacervation.

2. The method of claim 1, wherein the coacervation in f) is induced by increasing the pH of the composition obtained in e) to pI(A)<pH<pI(B), and/or
wherein coacervation in f) is induced by dilution of the composition obtained in e), wherein said dilution is optionally achieved by adding water to the composition obtained in e).

3. The method according to claim 1, wherein pI(A) is from 6.5 to 8, optionally from 6.5 to 7.5 and optionally from 7 to 7.5 and/or
wherein pI(B) is from 9 to 14, optionally from 9.5 to 13 and optionally from 10 to 12.

4. The method according to claim 1, wherein protein A is a globulin and wherein protein B is an albumin, and wherein protein A is optionally cruciferin and wherein protein B is optionally napin, and wherein protein A is optionally rapeseed cruciferin and wherein protein B is optionally rapeseed napin.

5. The method according to claim 1, wherein the composition of c) is provided by mixing a rapeseed protein isolate with water, wherein said rapeseed protein isolate is optionally a native rapeseed protein isolate comprising 40 to 65% on dry matter of cruciferins and 35 to 60% on dry matter of napins and/or having a solubility of at least 88% when measured over a pH range from 3 to 10 at a temperature of 23±2° C.

6. The method according to claim 1, wherein said at least one lipophilic compound is sensitive to acid and/or wherein said at least one lipophilic compound is selected from the group consisting of vitamins, carotenoids, lipids, edible polymers and active pharmaceutical ingredients.

7. The method according to claim 1, wherein said at least one lipophilic compound is an oil, and wherein said oil comprises optionally polyunsaturated fatty acids, and wherein said oil is optionally fish oil comprising polyunsaturated fatty acids or algae oil comprising polyunsaturated fatty acids, and wherein said oil comprises optionally docosahexaenoic acid (DHA) and/or eicosapentaenoic acid (EPA).

8. The method according to claim 1, wherein the composition obtained in d) comprises:
i) at least 30 weight-%, optionally at least 40 weight-% and optionally at least 50 weight-% water, based on the total weight of the composition;
ii) from 1 to 10 weight-%, optionally from 2 to 9 weight-% and optionally from 3 to 8 weight-% protein A, based on the total weight of the composition;
iii) from 1 to 10 weight-%, optionally from 2 to 9 weight-% and optionally from 3 to 8 weight-% protein B, based on the total weight of the composition;
iv) from 1 to 60 weight-%, optionally from 1 to 50 weight-% and optionally from 1 to 40 weight-% of the at least one lipophilic compound, based on the total weight of the composition; and
v) optionally at least one further excipient,
wherein the amounts of compounds i) to v) add up to 100 weight-%.

9. The method according to claim 1, wherein said method further comprises:
g) inducement of crosslinking,
wherein said crosslinking is optionally induced by heating the composition obtained in f) or by adding a crosslinking agent to the composition obtained in f), wherein said crosslinking agent is optionally an enzyme, and wherein said enzyme is optionally transglutaminase.

10. A coacervate capsule obtainable according to claim 1, wherein said coacervate capsule comprises protein A and protein B, and wherein protein A is a globulin and wherein protein B is an albumin.

11. The coacervate capsule according to claim 10, wherein the weight ratio between protein A and protein B is between 3:1 and 1:3, optionally between 2:1 and 1:2 and optionally between 1.5:1 and 1:1.5.

12. The coacervate capsule according to claim 10, wherein the weight ratio between the at least one lipophilic compound and protein A is between 20:1 and 1:1, optionally between 15:1 and 2:1 and optionally between 10:1 and 3:1.

13. A product comprising a protein isolate for manufacturing coacervates, wherein said protein isolate comprises protein A and protein B, and wherein the isoelectric point pI(A) of said protein A is from 6 to 8, and wherein the isoelectric point pI(B) of said protein B is at least 9.

14. The product according to claim 13, wherein protein A is a globulin and wherein protein B is an albumin, and wherein protein A is optionally cruciferin and wherein protein B is optionally napin, and wherein protein A is optionally rapeseed cruciferin and wherein protein B is optionally rapeseed napin.

15. The product according to claim 13, wherein said protein isolate is native rapeseed protein isolate comprising 40 to 65% on dry matter of cruciferins and 35 to 60% on dry matter of napins and/or having a solubility of at least 88% when measured over a pH range from 3 to 10 at a temperature of 23±2° C. and wherein the native rapeseed protein isolate comprises optionally from 5% to 65% on dry matter of 12S rapeseed protein where the presence of 12S is verified by Blue Native PAGE.
